(19) United States
(12) Patent Application Publication
(10) Pub. No.: US 2024/0232885 A1
(43) Pub. Date: Jul. 11, 2024

(54) DEVICES, METHODS, COMPUTER-READABLE MEDIA, AND SYSTEMS FOR AUTHENTICATING USERS

(71) Applicant: MASTERCARD TECHNOLOGIES CANADA ULC, Vancouver (CA)

(72) Inventor: Igor Opushnyev, New Westminster (CA)

(21) Appl. No.: 18/403,999

(22) Filed: Jan. 4, 2024

Related U.S. Application Data
(60) Provisional application No. 63/478,594, filed on Jan. 5, 2023.

(51) Int. Cl. G06Q 20/40; G06Q 20/36; H04L 9/40

(52) U.S. Cl. CPC G06Q 20/4014; G06Q 20/3674; H04L 63/0853

(57) ABSTRACT

Devices, methods, computer-readable media, and systems for authenticating users. In one example, a computing device includes an electronic processor and a memory. The electronic processor is configured to receive a registration of an authentication device associated with a user, the authentication device connected to and operable to communicate over a first communications network, control the memory to store the registration of the authentication device, receive a transaction request by the user, responsive to receiving the transaction request, request an authentication operation to be performed by the authentication device, receive a result of the authentication operation performed by the authentication device, determine whether the result validates the transaction request by the user, and permit the transaction request by the user in response to determining that the result validates the transaction request by the user.

### CROSS-REFERENCE TO RELATED APPLICATION

This application claim priority to, and the benefit of, U.S. Provisional Application No. 63/478,594, filed on Jan. 5, 2023, the entire contents of which are incorporated herein by reference.

### FIELD OF THE INVENTION

Aspects of the present disclosure relate to systems, methods, computer-readable media, and devices for authenticating users

### BACKGROUND

Three-Domain Secure (3DS) is a messaging protocol that enables consumers to authenticate themselves with an issuer when making card-not-present transactions. The 3DS consists of a merchant/acquirer domain, an issuer domain, and an interoperability domain. However, 3DS 1.0 is vulnerable to phishing attacks as the authentication window itself is not verified.

3DS 2.0 is less vulnerable than 3DS 1.0 and allows for contextual data to be sent to the customer's bank (including mailing addresses and transaction history) to verify and assess the risk of the transaction. The customer would only be required to pass an authentication challenge when their transaction is determined to be of a high risk. In addition, 3DS 2.0 does not require a re-direct to a separate page and may activate an out-of-band authentication via an institution's mobile app (which, in turn, can also be used with biometric authentication). However, 3DS 2.0 requires more customer interaction because 3DS 2.0 requires the customer to pass the authentication challenge when the transaction is a card-not-present transaction and determined to be high risk.

### SUMMARY

Embodiments described herein provide various combinations of active and passive authentication techniques that may be employed to authenticate a user with the 3DS 2.0 protocol without requiring the user to pass the 3DS 2.0 authentication challenge.

Embodiments described herein provide a computing device. The computing device includes an electronic processor and a memory. The electronic processor is configured to receive a registration of an authentication device associated with a user, the authentication device connected to and operable to communicate over a first communications network, control the memory to store the registration of the authentication device, receive a transaction request by the user, responsive to receiving the transaction request, request an authentication operation to be performed by the authentication device, receive a result of the authentication operation performed by the authentication device, determine whether the result validates the transaction request by the user, and permit the transaction request by the user in response to determining that the result validates the transaction request by the user.

Embodiments described herein provide a method. The method includes receiving, with an electronic processor, a registration of an authentication device associated with a user, the authentication device connected to and operable to communicate over a first communications network. The method includes controlling, with the electronic processor, a memory to store the registration of the authentication device. The method includes receiving, with the electronic processor, a transaction request by the user. The method includes responsive to receiving the transaction request, requesting, with the electronic processor, an authentication operation to be performed by the authentication device. The method includes receiving, with the electronic processor, a result of the authentication operation performed by the authentication device. The method includes determining, with the electronic processor, whether the result validates the transaction request by the user. The method also includes permitting, with the electronic processor, the transaction request by the user in response to determining that the result validates the transaction request by the user.

### BRIEF DESCRIPTION OF DRAWINGS

FIG. 1 is a diagram illustrating a system via which digital interactions may take place, in accordance with some embodiments.

FIG. 2 is a diagram illustrating a security system for processing data collected from digital interactions, in accordance with some embodiments.

FIG. 3 illustrates an environment associated with a user, in accordance with some embodiments.

FIG. 4 illustrates a process that may be carried out by a security system to dynamically probe one or more connected devices, in accordance with some embodiments.

FIG. 5 shows, schematically, a computing device on which any aspect of the present disclosure may be implemented.

FIG. 6 is a flowchart illustrating a method for authenticating an identity of a user, in accordance with some embodiments.

### DETAILED DESCRIPTION

Various combinations of active and passive authentication techniques may be employed to authenticate a user. For example, data or information can be gathered from a variety of devices associated with or in proximity to a user's device (e.g., by probing for devices connected to a network). Based on the data or information from one or more of these devices, and employing active, passive, or a combination of active and passive authentication techniques in relation to the one or more devices, the user can be authenticated. As an illustrative example, a user's device (e.g., a mobile phone, tablet, etc.) may be in proximity to one or more additional devices or operate on the same network as one or more additional devices. These one or more additional devices gather or transmit information about how the devices are being used, the status of the devices, the location of the devices, etc. The user's device can receive or gather this information passively without the user needing to actively input any information (e.g., due to unencrypted communication over a network), or the user's device actively communicates with the devices. For example, signal strength to the hub based on Wi-Fi and Bluetooth, what current devices are connected, when was the last time the current devices were used, whether any significant settings on the current devices has changed. Each personal area network may have a history built up so if significant things change passively (without prompting the user), the user's device may record these changes.

These devices can be used to generate or create an environmental fingerprint for the user and the user's device. The “environmental fingerprint” may be used for passive authentication.

The environmental fingerprint, for example, would include information about the devices in proximity to the user's device or operating over the same network as the user's device. In a home setting, the environmental fingerprint could include a variety of devices that communicate over a home WiFi network (e.g., smart refrigerator, smart TV, smart thermostat, smart lightbulbs, or other suitable smart device). Knowing or predicting the precise configuration of all the devices that would have such a relationship to the user's device would be very difficult.

Additionally or alternatively to passive authentication, one or more of the devices in proximity to the user's device or operating on the same network as the user's device can be actively or dynamically probed in order to gather additional information about the environment around the user's device (e.g., assuming any required permission for communicating with or controlling the devices has been given). For example, a user could be prompted to turn a smart lightbulb ON or OFF, and the smart lightbulb being turned ON or turned OFF can be detected based on information the smart lightbulb sends to the network. The “user prompt” and a user's response to the “user prompt” is an active user authentication. However, as explained above, active user authentication places a burden on the user to always be in a position to respond to the “user prompt.”

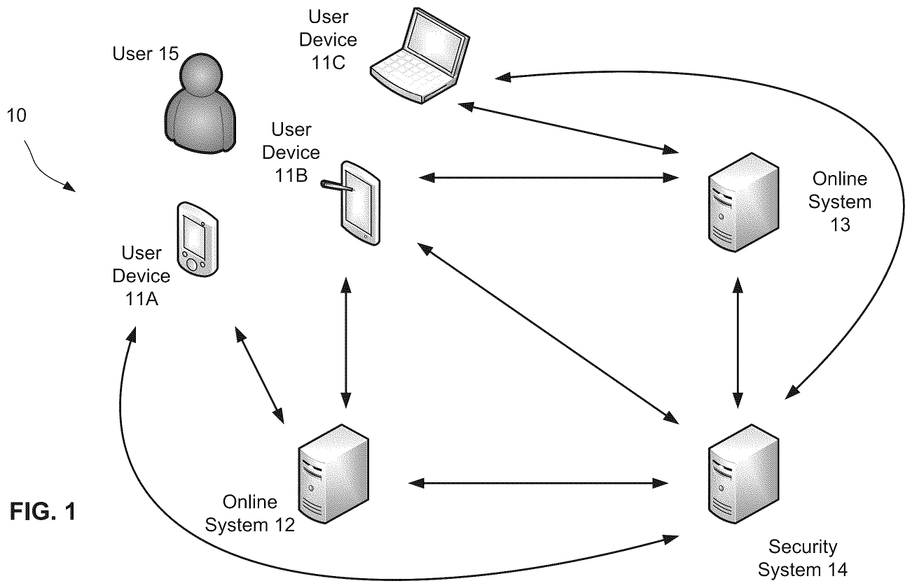

The present disclosure reduces or eliminates the burden on the user to always be in a position to respond to the “user prompt” with an active device authentication. FIG. 1 is a diagram illustrating a system 10 via which digital interactions may take place, in accordance with some embodiments. In this example, the system 10 includes user devices 11A-C, online systems 12 and 13 (e.g., servers, remote computation devices, etc.), and a security system 14 (e.g., one or more servers, one or more remote computation devices, etc.). A user 15 may use the user devices 11A-C to engage in digital interactions. For instance, the user device 11A may be a smart phone and may be used by the user 15 to check email and download music, the user device 11B may be a tablet computer and may be used by the user 15 to shop and bank, and the user device 11C may be a laptop computer and may be used by the user 15 to watch TV and play games.

It should be appreciated that the user 15 may engage in other types of digital interactions in addition to, or instead of, those mentioned above, as aspects of the present disclosure are not limited to the analysis of any particular type of digital interactions. Also, digital interactions are not limited to interactions that are conducted via an Internet connection. For example, a digital interaction may involve an ATM transaction over a leased telephone line.

Furthermore, it should be appreciated that the particular combination of user devices 11A-C is provided solely for purposes of illustration, as the user 15 may use any suitable device or combination of devices to engage in digital interactions, and the user may use different devices to engage in a same type of digital interactions (e.g., checking email).

In some embodiments, a digital interaction may involve an interaction between the user 15 and an online system, such as the online system 12 or the online system 13. For instance, the online system 12 may include an application server that hosts a backend of a banking app used by the user 15, and the online system 13 may include a web server that hosts a retailer's web site that the user 15 visits using a web browser. It should be appreciated that the user 15 may interact with other online systems (not shown) in addition to, or instead of the online systems 12 and 13.

For example, the user 15 may visit a pharmacy's web site to have a prescription filled and delivered, a travel agent's web site to book a trip, a government agency's web site to renew a license, etc.

In some embodiments, the user 15 may register one or more devices (e.g., the user devices 11A-11C) with the security system 14 and associate the one or more devices with one or more remuneration vehicles. Each of the one or more devices include a registration application that performs the registration with the security system 14. In some examples, the security system 14 is a 3DS2 Access Control Server.

After the user 15 registers the one or more user devices with the security system 14, when the user 15 performs a digital interaction that involves the one or more remuneration vehicles, the security system 14 determines whether the digital interaction is classified as both a “high risk” and “vehicle-not-present” transaction, which requires an authentication challenge under the 3DS 2.0 protocol.

When the security system 14 determines that the digital interaction is classified as a “high risk” and “vehicle-not-present” transaction, the security system 14 sends the authentication challenge under the 3DS 2.0 protocol to one or more of the one or more user devices that are registered with the security system 14. Typically, with the 3DS 2.0 protocol, the user 15 would need to respond to the authentication challenge in order for the digital interaction to be permitted by the security system 14. However, in the system 10, the one or more user devices that are registered with the security system 14 may perform the authentication challenge in place of the user 15.

For example, the user device 11B may include an authentication application within or in addition to the registration application. The user device 11B may execute the authentication application to detect receipt of an authentication challenge by the security system 14, generate a response to the authentication challenge, and transmit the authentication challenge back to the security system 14.

The registration application and the authentication application may be separate applications or portions of a larger application (e.g., a bank application or other higher-level application). These applications may be written in any suitable programming language, and may be delivered to a user device in any suitable manner. For example, the software may be delivered by a firewall (e.g., an application firewall), a network operator (e.g., an Internet Service Provider (ISP), a Cellular Network Provider, etc.), a network accelerator (e.g., Akamai), or any device along a communication path between the user device and an online system, or between the user device and a security system.

Although only one user (i.e., the user 15) is shown in FIG. 1, it should be appreciated that the security system 14 may be programmed to challenge many users across the Internet. Furthermore, it should be appreciated that the security system 14 may interact with other online systems (not shown) in addition to, or instead of the online systems 12 and 13.

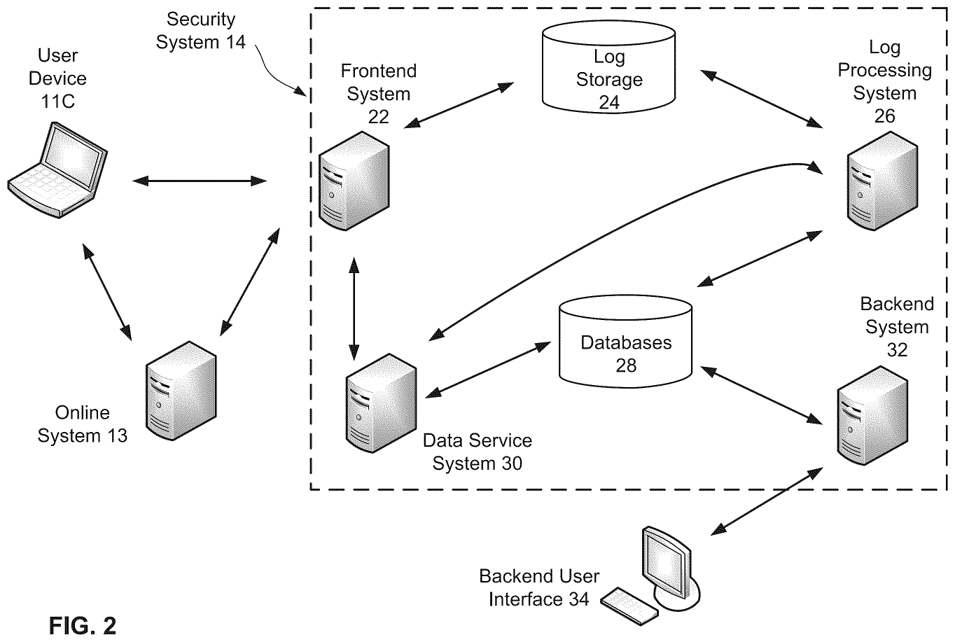

FIG. 2 is a diagram illustrating a security system 14 for processing data collected from digital interactions, in accordance with some embodiments. In this example, the security system 14 includes one or more frontend systems and/or one or more backend systems. For instance, the security system 14 may include a frontend system 22 configured to interact with user devices (e.g., the user device 11C in FIG. 1) and/or online systems (e.g., the online system 13 in FIG. 1). Additionally, or alternatively, the security system 14 may include a backend system 32 configured to interact with a backend user interface 34. In some embodiments, the backend user interface 34 may include a graphical user interface (e.g., a dashboard) for displaying current observations and/or historical trends regarding individual users and/or populations of users. Such an interface may be delivered in any suitable manner (e.g., as a web application or a cloud application), and may be used by any suitable party (e.g., security personnel of an organization).

In the example shown in FIG. 2, the security system 14 includes a log storage 24. The log storage 24 may store log files comprising data received by the frontend system 22 from user devices (e.g., the user device 11C), online systems (e.g., the online system 13), and/or any other suitable sources. A log file may include any suitable information. For instance, in some embodiments, a log file may include authentication challenge transmission times, authentication challenge response receipt times, successful authentication responses, unsuccessful authentication responses, and other suitable authentication information. Additionally, or alternatively, a log file may include other information of interest, such as account identifier, network address, user device identifier, user device characteristics, URL accessed, Stock Keeping Unit (SKU) of viewed product, etc.

In some embodiments, a log processing system 26 may be provided to filter, transform, and/or route data from the log storage 24 to one or more databases 28. The log processing system 26 may be implemented in any suitable manner. For instance, in some embodiments, the log processing system 26 may include one or more services configured to retrieve a log file from the log storage 24, extract useful information from the log file, transform one or more pieces of extracted information, and/or store the extracted and/or transformed information in one or more appropriate databases (e.g., among the one or more databases 28).

The one or more databases 28 may be accessed by any suitable component of the security system 14. As one example, the backend system 32 may query the one or more databases 28 to generate displays of current observations and/or historical trends regarding individual users and/or populations of users. As another example, a data service system 30 may query the one or more databases 28 to provide input to the frontend system 22.

In some embodiments, the data service system 30 may include a plurality of data services (e.g., implemented using a service-oriented architecture). For example, one or more data services may access the one or more databases 28 periodically (e.g., every hour, every few hours, every day, etc.), and may analyze the accessed data and populate one or more first data sources used by the frontend system 22. Additionally, or alternatively, one or more data services may receive data from the log processing system 26, and may use the received data to update one or more second data sources used by the frontend system 22. Such a second data source may supplement the one or more first data sources with recent data that has arrived since the last time the one or more first data sources were populated using data accessed from the one or more databases 28. In various embodiments, the one or more first data sources may be the same as, or different from, the one or more second data sources, or there may be some overlap.

Although details of implementation are shown in FIG. 2 and discussed above, it should be appreciated that aspects of the present disclosure are not limited to the use of any particular component, or combination of components, or to any particular arrangement of components. Furthermore, each of the frontend system 22, the log processing system 26, the data service system 30, and the backend system 32 may be implemented in any suitable manner, such as using one or more parallel processors operating at a same location or different locations.

In some embodiments, improved techniques are provided for authenticating users who are interacting with online systems that use the 3DS 2.0 protocol. For example, many users own a variety of network capable devices. Such devices may communicate with each other in a user's environment (e.g., the user's home, office, classroom, library, favorite coffee shop, or any other suitable environment). Examples of connected devices include, but are not limited to, desktop computers, laptop computers, and various smart devices such as watches, refrigerators, thermostats, garage door openers, light fixtures, washing machines, drones, sound systems, televisions, cable boxes, automobiles, and/or garments. As indicated above, in embodiments, a security system, such as security system 14, may use an authentication response from one or more user devices that are registered by the user to authenticate the user without requiring the user's response.

Use of the present disclosure makes it more challenging for an attacker to spoof a user's identity with a high likelihood of success. For instance, it may be challenging for an attacker to know which devices are expected to be present in the user's environment, and/or whether those devices are registered with a security system. Therefore, by requiring that registered user devices respond to an authentication challenge in place of the user and by verifying authentication responses, the security system may increase a level of confidence that an entity purporting to be the user may indeed be the user, or at least be physically present in the user's environment.

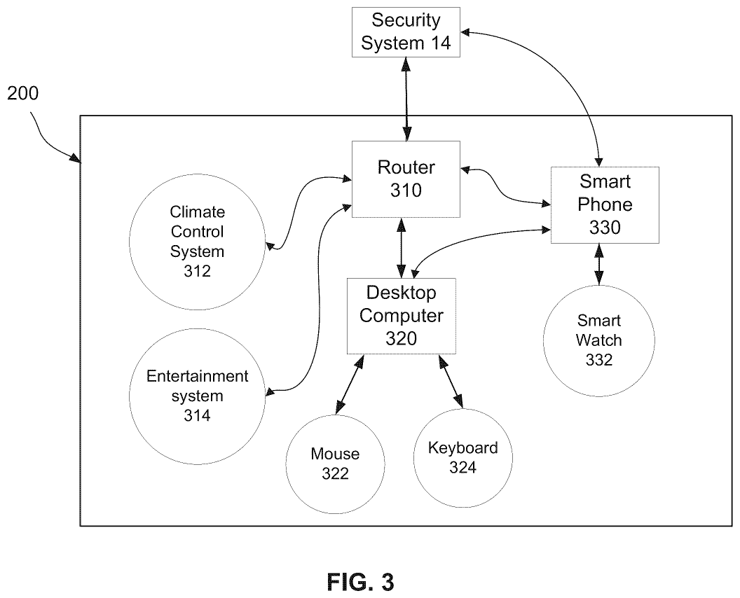

FIG. 3 illustrates an environment 300 associated with a user, in accordance with some embodiments. In this example, the environment 300 is the user's home, with multiple network-capable devices arranged in an illustrative network topology. For instance, the environment 300 may include a router 310, a desktop computer 320, and a smart phone 330. A mouse 322 and a keyboard 324 may be connected to the desktop computer 320. A smart watch 332 may be connected to the smart phone 330, which in turn may be connected to the desktop computer 320. The desktop computer 320 and the smart phone 330 may be both connected to the router 310. The environment 300 may also include a climate control system 312 and an entertainment system 314, both of which may be connected to the router 310. It should be appreciated that these devices are shown in FIG. 3 and described herein solely for purposes of illustration, as aspects of the present disclosure are not limited to the use of any particular number or combination of devices. It should also be appreciated that the environment fingerprint of devices in the environment 300 may be associated with multiple end users (e.g., multiple members of the same family).

It should also be appreciated that the devices in the environment 300 may be connected in any suitable manner, for example, via wired or wireless connections. For instance, the mouse 322 and the keyboard 324 may be connected to the desktop computer 320 via USB cables, whereas each of the smart phone 330, the desktop computer 320, the climate control system 312, and the entertainment system 314 may be connected to the router 310 via a Wi-Fi connection. The smart watch 332 may be connected to the smart phone 330 using a low power and/or short range communications protocol, such as Bluetooth® Low Energy (BLE). One or more other suitable networking technologies may also be used, as aspects of the present disclosure are not limited to any particular networking technology or combination of networking technologies.

In some embodiments, a security system (e.g., the security system 14 in the example of FIG. 1) may deploy one or more software agents (e.g., the registration application and the authentication application) to any of the devices in the environment 300. The one or more software agents may be downloaded and deployed as part or all of a native or web application on an Internet-enabled device. The information may be communicated to the security system 14, for example, via the router 310 and a cable network, the smart phone 330 and a cellular network, and/or any other device (e.g., a centralized IoT hub or an individual IoT device) with access to the Internet via a suitable communication link.

In some embodiments, the security system 14 may use information collected by the one or more software agents to generate an environment fingerprint for the environment 300. For instance, the environment fingerprint may include information indicative of one or more devices that are expected to be present in the environment 300. Additionally, or alternatively, the environment fingerprint may for at least one first expected device, include information indicative of one or more second expected devices that are connected to the first expected device, and/or information indicative of respective connection types for the one or more second expected devices. As networked devices are frequently enabled to identify themselves to other devices on the local network, a fingerprint may be created from collected identifying information.

In some embodiments, the security system 14 may associate the environment fingerprint for the environment 300 with an identifier of the user (e.g., account identifier, user name, email address, phone number, credit card number, billing address, etc.), and may use the environment fingerprint for authentication during a future digital interaction. For instance, when an entity purporting to be the user initiates a digital interaction with an online system (e.g., the online system 12 or 13 in the example of FIG. 1), the security system 14 may match the digital interaction to an environment fingerprint associated with the user. As an example, if the digital interaction is purportedly initiated through the desktop computer 320, the security system 14 may select the environment fingerprint generated for the environment 300, because the desktop computer 320 is known to exist in the environment 300 (which, in the example of FIG. 3, is the user's home).

In some embodiments, the security system 14 may determine whether one or more expected devices indicated in the environment fingerprint are indeed present. As an example, the security system 14 may identify a network device via which a device purporting to be the desktop computer 320 is connected to the Internet, and determine whether that network device is the router 310, for example by assessing the IP or MAC address of the network device. Additionally, or alternatively, the security system 14 may identify one or more other devices that are also connected to the network device, and determine whether any of the other devices is the climate control system 312, the entertainment system 314, or the smart phone 330. This identification is performed using a software agent, deployed within application software running on the desktop computer. When the device reports incorrect information, the security system 14 may flag the digital interaction as “high-risk” and require an authentication challenge under the 3DS 2.0 protocol.

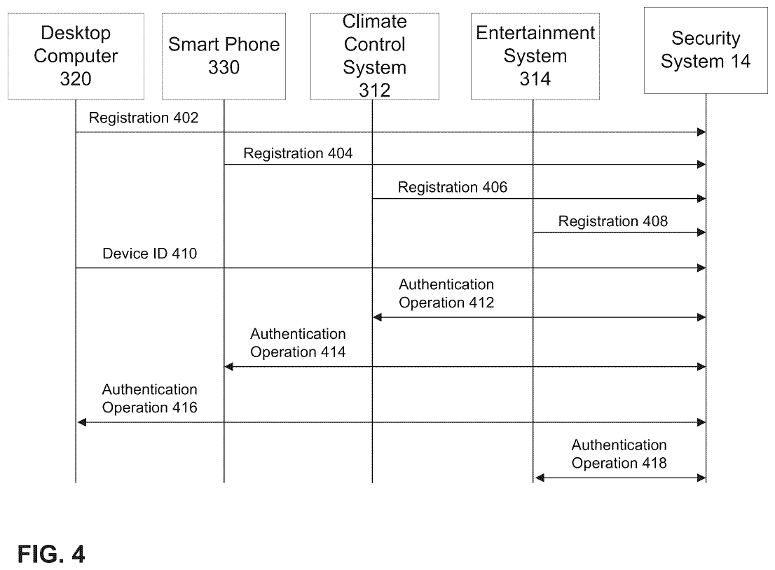

As indicated above, enhanced security may be provided by registering a device in a user's environment to take the user's place while responding to the authentication challenge under the 3DS 2.0 protocol. FIG. 4 illustrates a process 400 that may be carried out by a security system to dynamically probe one or more connected devices, in accordance with some embodiments. For instance, the process 400 may be performed by the security system 14 in the example of FIGS. 2 and 3 and the desktop computer 320, the smart phone 330, the climate control system 312, and the entertainment system 314 in the example of FIG. 3.

In some embodiments, as explained above, the security system 14 may perform passive authentication during a digital interaction, for example, by surreptitiously polling a connected device that is expected to be in the user's environment. However, when passive authentication for the digital interaction indicates a “high risk” interaction, then the security system 14 may use active authentication with the 3DS 2.0 protocol and a user device registered by the user.

As illustrated in FIG. 4, a user may initially register one or more devices (e.g., the desktop computer 320, the smart phone 330, the climate control system 312, and the entertainment system 314) with the security system 14 at registration operations 402-408.

After registration, in the example of FIG. 4, an entity purporting to be the user may access a web application or otherwise initiate a digital interaction with an online system (e.g., the online system 12 or 13 in the example of FIG. 1). At operation 410, information regarding the digital interaction may be communicated to the security system 14, such as an identifier of a device used by the entity to initiate the digital interaction. This information may be communicated to the security system 14 directly, or via the online system 12 or 13. If the entity is indeed the user, and the device used to initiate the digital interaction is indeed a device in the user's environment (e.g., the desktop computer 320), the device may provide accurate information. However, if the entity is an attacker, or a bot controlled by the attacker, the device may provide false information. For instance, the device may provide a device identifier (e.g., a media access control (MAC) address) of the desktop computer 320, instead of its own device identifier.

In some embodiments, to determine whether the digital interaction is indeed initiated from the desktop computer 320, the security system 14 may identify a registered authentication device associated with the desktop computer 320 (devices registered at operations 402-408). For instance, the security system 14 may use an identifier of the user to identify one or more registered authentication devices (e.g., the smart phone 330, the climate control system 312, and/or the entertainment system 314) that are expected to be in the same environment as the user and the desktop computer 333320.

In some embodiments, the security system 14 may, at authentication operation 412, poll one or more of the one or more registered authentication devices that are expected to be in the same environment as the user. For instance, the security system 14 may request that a thermostat associated with the climate control system 312 perform the authentication operation 412 (i.e., respond to an authentication challenge), and report the authentication result back to the security system 14. The security system 14 may check if the reported authentication result is valid. When the reported value at the authentication operation 412 is invalid or not received, the security system 14 may flag a potential spoofing attack.

At authentication operation 414, the security system 14 may send a command to a different registered device (e.g., the smart phone 330) to perform the authentication operation 414, and report the second authentication result back to the security system 14. When the reported value at operation 414 is invalid or not received, the security system 14 may flag a potential spoofing attack.

The flag is used to ensure that all of these devices in fact belong to the user. For example, if a user has a personal area network that includes a Wi-Fi thermostat, when the user completes an action that leverages the personal area network (PAN), a method to authenticate the user may request an authentication operation by the Wi-Fi thermostat.

Similar authentication operations to authentication operations 412 and 414 (e.g., authentication operations 416 and 418) may also be performed by the desktop computer 320 or the entertainment system 314. However, an authentication operation may be performed by any computing device that is registered by the user.

It should also be appreciated that the communications shown in FIG. 4 are provided solely for purposes of illustration, as other forms of communications may also be suitable (e.g., with different types of devices and/or different requested actions). Any communication with any registered device, and/or between two or more registered devices, in a user's environment may be initiated and/or analyzed to authenticate the user.

In some implementations, the security system 14 may be configured to perform passive verification first. If the passive verification indicates a high risk, active validation may be triggered. In other words, the security system 14 prefers to leverage the ability to passively identify/authenticate the user when the security system 14 detects that the same device, the same personal area network, the same devices on the personal area network fall within a normal history of information, or other suitable information with respect to the personal area network. In this case, the security system 14 determines there is no need to perform strong consumer authentication (SCA). However, when the security system 14 identifies any level of uncertainty with respect to the identification/authentication of the user, then the security system 14 may perform SCA by invoking an authentication by a registered authentication device. Put simply, the passive system notices some uncertainty, so active SCA authentication is invoked.

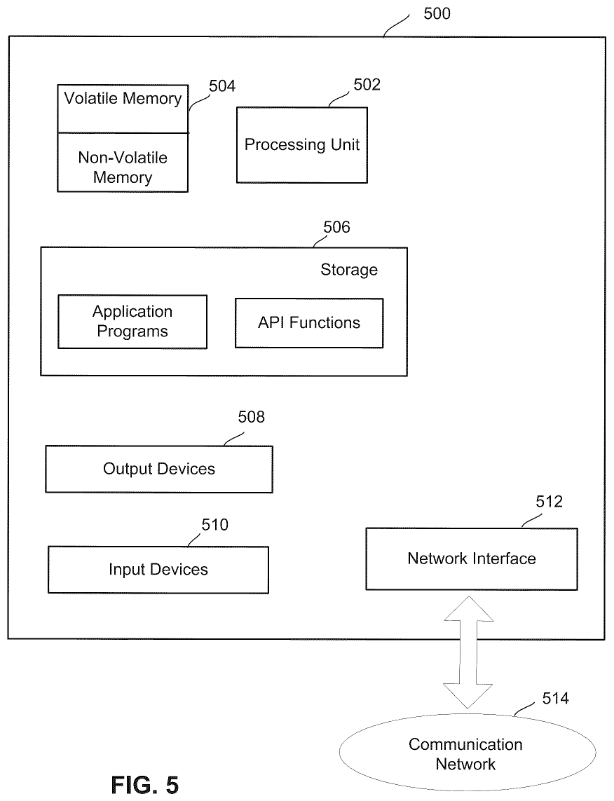

FIG. 5 shows, schematically, a computing device 500 on which any aspect of the present disclosure may be implemented. In the embodiment shown in FIG. 5, the computing device 500 includes a processing unit 502 having one or more electronic processors and a non-transitory computer-readable storage medium 504 that may include, for example, volatile and/or non-volatile memory. The memory 504 may store one or more instructions to program the processing unit 502 to perform any of the functions described herein. The computing device 500 may also include other types of non-transitory computer-readable medium, such as storage 506 (e.g., one or more disk drives) in addition to the system memory 504. The storage 506 may also store one or more application programs, one or more external components used by application programs (e.g., software libraries), and/or one or more operating systems, which may be loaded into the memory 504.

The computing device 500 may have one or more input devices and/or output devices, such as devices 508 and 510 illustrated in FIG. 5. These devices can be used, among other things, to present a user interface. Examples of output devices that can be used to provide a user interface include printers or display screens for visual presentation of output and speakers or other sound generating devices for audible presentation of output. Examples of input devices that may be used for a user interface include keyboards and pointing devices, such as mice, touch pads, and digitizing tablets. As another example, the input devices 510 may include a microphone for capturing audio signals, and the output devices 508 may include a display screen for visually rendering, and/or a speaker for audibly rendering, recognized text.

As shown in FIG. 5, the computing device 500 may also include one or more network interfaces (e.g., the network interface 512) to enable communication via various networks (e.g., the network 514). Examples of networks include a local area network or a wide area network, such as an enterprise network or the Internet. Such networks may be based on any suitable technology and may operate according to any suitable protocol and may include wireless networks or wired networks (e.g., copper wire, fiber optic, etc.).

In some embodiments, the computing device 500 is operable to authenticate a user based on the information that is gathered actively and passively related to one or more devices associated with the user's device. The information can include any of the information gathered using the above-described techniques. After all of the information has been gathered or aggregated, the computing device 500 analyzes the information to assess whether enough information has been obtained to authenticate a user. The amount of information that is required to authenticate a user can vary depending upon the type of information that has been gathered. In some embodiments, a valid authentication result from one or more registered authentication devices that are registered by the user may be used to confirm authentication.

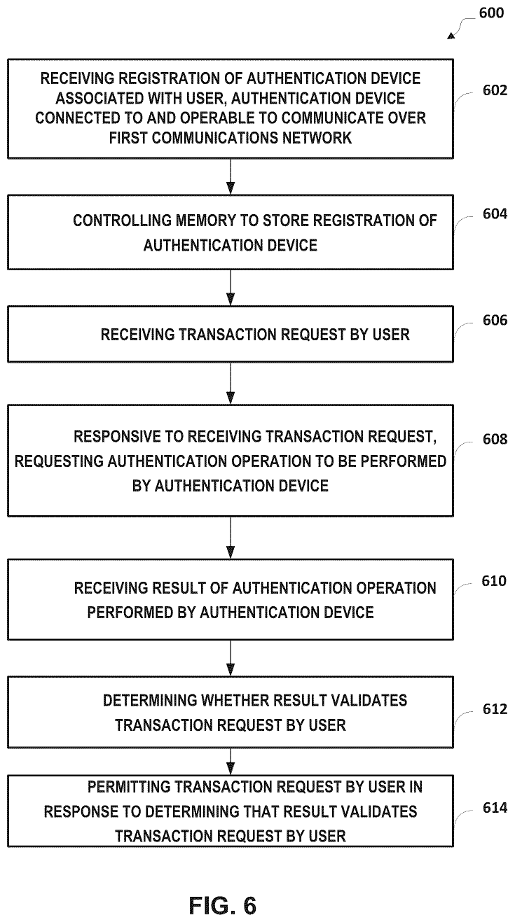

FIG. 6 is a flowchart illustrating a method 600 for authenticating an identity of a user, in accordance with some embodiments. FIG. 6 is described with respect to FIGS. 2 and 3.

The method 600 includes receiving, with an electronic processor, a registration of an authentication device associated with a user, the authentication device connected to and operable to communicate over a first communications network (at block 602).

The method 600 includes controlling, with the electronic processor, the memory to store the registration of the authentication device (at block 604).

The method 600 includes receiving, with the electronic processor, a transaction request by the user (at block 606).

The method 600 includes responsive to receiving the transaction request, requesting, with the electronic processor, an authentication operation to be performed by the authentication device (at block 608). For example, when the transaction is identified as a high-risk, the security system 14 sends a 3DS2 challenge request (CReq) to an application running on the user device 11A that initiated transaction. For automatic challenge processing, an example challenge may be “compute hash of available WI-FI access point names.”

The method 600 includes receiving, with the electronic processor, a result of the authentication operation performed by the authentication device (at block 610). For example, the user device 11A may send the challenge result with a Challenge Response message (Cres) to the security system 14.

The method 600 includes determining, with the electronic processor, whether the result validates the transaction request by the user (at block 612). For example, after the user device 11A sends the challenge result with Challenge Response message (CRes) to the security system 14, the security system 14 validates the challenge result, and consequently the transaction request by the user.

The method 600 also includes permitting, with the electronic processor, the transaction request by the user in response to determining that the result validates the transaction request by the user (at block 614). After the security system 14 validates the challenge result, the security system 14 sends an authentication response to the application running on the user device 11A. The application on the user device 11A forwards the authentication response to the merchant. The merchant validates the authentication response using 3DS2 protocol and approves transaction when the authentication response is valid.

In some examples, the method 600 may further include receiving a registration of a second authentication device associated with the user, the second authentication device being separate and distinct from the authentication device, and the second authentication device being connected to and operable to communicate over a second communications network, controlling the memory to store the registration of the second authentication device, receiving a second transaction request by the user, responsive to receiving the second transaction request, requesting a second authentication operation to be performed by at least one of the authentication device or the second authentication device, receiving one or more results of the second authentication operation performed by the at least one of the authentication device or the second authentication device, determining whether the one or more results validate the second transaction request by the user, and permitting the second transaction request by the user in response to determining that the result validates the second transaction request by the user.

Additionally, in these examples, the method 600 may further include receiving a registration of a third authentication device associated with the user, the third authentication device being separate and distinct from the authentication device and the second authentication device, and the second authentication device being connected to and operable to communicate over a third communications network, controlling the memory to store the registration of the third authentication device, receiving a third transaction request by the user, responsive to receiving the third transaction request, requesting a third authentication operation to be performed by at least one of the authentication device, the second authentication device, or the third authentication device, receiving one or more results of the third authentication operation performed by the at least one of the authentication device, the second authentication device, or the third authentication device, determining whether the one or more results validate the third transaction request by the user, and permitting the third transaction request by the user in response to determining that the result validates the third transaction request by the user.

In some examples, the authentication device, the second authentication device, and the third authentication device are individually one of a smartphone, a tablet, laptop computer, a desktop computer, a smart watch, a smart refrigerator, a smart thermostat, a smart garage door opener, a smart light device, a smart washing machine, a drone, a smart sound system, a smart television, a smart set-top box, an automobile, or smart clothing. Additionally, in some examples, the first communications network, the second communications network, and the third communications network are individually one of a local area network (LAN), a personal area network (PAN), a wireless local area network (WLAN), a wide area network (WAN), an enterprise private network (EPN), or a system-area network (SAN).

Lastly, in some examples, the method 600 may further include responsive to receiving the transaction request, determining whether a change has occurred with respect to the first communications network from a previous transaction request by the user, responsive to determining that the change has not occurred with respect to the first communications network from a previous transaction request, requesting the authentication operation to be performed by the authentication device; and responsive to determining that the change has occurred with respect to the first communications network from the previous transaction request, initiating a strong consumer authentication of the user.

Having thus described several aspects of at least one embodiment, it is to be appreciated that various alterations, modifications, and improvements will readily occur to those skilled in the art. Such alterations, modifications, and improvements are intended to be within the spirit and scope of the present disclosure. Accordingly, the foregoing description and drawings are by way of example only, and the following are non-limiting enumerated examples of the present disclosure.

The following are enumerated examples of the devices, methods, and computer-readable media for authenticating users of the present disclosure. Example 1: a computing device comprising: an electronic processor; and a memory, wherein the electronic processor is configured to: receive a registration of an authentication device associated with a user, the authentication device connected to and operable to communicate over a first communications network, control the memory to store the registration of the authentication device, receive a transaction request by the user, responsive to receiving the transaction request, request an authentication operation to be performed by the authentication device, receive a result of the authentication operation performed by the authentication device, determine whether the result validates the transaction request by the user, and permit the transaction request by the user in response to determining that the result validates the transaction request by the user.

Example 2: the computing device of Example 1, wherein the authentication operation is an authentication challenge according to a 3DS 2.0 protocol.

Example 3: the computing device of Examples 1 or 2, wherein the electronic processor is further configured to: receive a registration of a second authentication device associated with the user, the second authentication device being separate and distinct from the authentication device, and the second authentication device being connected to and operable to communicate over a second communications network, control the memory to store the registration of the second authentication device, receive a second transaction request by the user, responsive to receiving the second transaction request, request a second authentication operation to be performed by at least one of the authentication device or the second authentication device, receive one or more results of the second authentication operation performed by the at least one of the authentication device or the second authentication device, determine whether the one or more results validate the second transaction request by the user, and permit the second transaction request by the user in response to determining that the result validates the second transaction request by the user.

Example 4: the computing device of Example 3, wherein the electronic processor is configured to: receive a registration of a third authentication device associated with the user, the third authentication device being separate and distinct from the authentication device and the second authentication device, and the second authentication device being connected to and operable to communicate over a third communications network, control the memory to store the registration of the third authentication device, receive a third transaction request by the user, responsive to receiving the third transaction request, request a third authentication operation to be performed by at least one of the authentication device, the second authentication device, or the third authentication device, receive one or more results of the third authentication operation performed by the at least one of the authentication device, the second authentication device, or the third authentication device, determine whether the one or more results validate the third transaction request by the user, and permit the third transaction request by the user in response to determining that the result validates the third transaction request by the user.

Example 5: the computing device of Example 4, wherein the authentication device, the second authentication device, and the third authentication device are individually one of a smartphone, a tablet, laptop computer, a desktop computer, a smart watch, a smart refrigerator, a smart thermostat, a smart garage door opener, a smart light device, a smart washing machine, a drone, a smart sound system, a smart television, a smart set-top box, an automobile, or smart clothing.

Example 6: the computing device of Examples 4 or 5, wherein the first communications network, the second communications network, and the third communications network are individually one of a local area network (LAN), a personal area network (PAN), a wireless local area network (WLAN), a wide area network (WAN), an enterprise private network (EPN), or a system-area network (SAN).

Example 7: the computing device of any of Examples 1-6, wherein the electronic processor is further configured to responsive to receiving the transaction request, determine whether a change has occurred with respect to the first communications network from a previous transaction request by the user, responsive to determining that the change has not occurred with respect to the first communications network from a previous transaction request, request the authentication operation to be performed by the authentication device, responsive to determining that the change has occurred with respect to the first communications network from the previous transaction request, initiate a strong consumer authentication of the user.

Example 8: a method comprising: receiving, with an electronic processor, a registration of an authentication device associated with a user, the authentication device connected to and operable to communicate over a first communications network; controlling, with the electronic processor, a memory to store the registration of the authentication device; receiving, with the electronic processor, a transaction request by the user; responsive to receiving the transaction request, requesting, with the electronic processor, an authentication operation to be performed by the authentication device; receiving, with the electronic processor, a result of the authentication operation performed by the authentication device; determining, with the electronic processor, whether the result validates the transaction request by the user; and permitting, with the electronic processor, the transaction request by the user in response to determining that the result validates the transaction request by the user.

Example 9: the method of Example 8, wherein the authentication operation is an authentication challenge according to a 3DS 2.0 protocol.

Example 10: the method of Examples 8 or 9, further comprising: receiving a registration of a second authentication device associated with the user, the second authentication device being separate and distinct from the authentication device, and the second authentication device being connected to and operable to communicate over a second communications network; controlling the memory to store the registration of the second authentication device; receiving a second transaction request by the user; responsive to receiving the second transaction request, requesting a second authentication operation to be performed by at least one of the authentication device or the second authentication device; receiving one or more results of the second authentication operation performed by the at least one of the authentication device or the second authentication device; determining whether the one or more results validate the second transaction request by the user; and permitting the second transaction request by the user in response to determining that the result validates the second transaction request by the user.

Example 11: the method of Example 10, further comprising: receiving a registration of a third authentication device associated with the user, the third authentication device being separate and distinct from the authentication device and the second authentication device, and the second authentication device being connected to and operable to communicate over a third communications network; controlling the memory to store the registration of the third authentication device; receiving a third transaction request by the user; responsive to receiving the third transaction request, requesting a third authentication operation to be performed by at least one of the authentication device, the second authentication device, or the third authentication device; receiving one or more results of the third authentication operation performed by the at least one of the authentication device, the second authentication device, or the third authentication device; determining whether the one or more results validate the third transaction request by the user; and permitting the third transaction request by the user in response to determining that the result validates the third transaction request by the user.

Example 12: the method of Example 11, wherein the authentication device, the second authentication device, and the third authentication device are individually one of a smartphone, a tablet, laptop computer, a desktop computer, a smart watch, a smart refrigerator, a smart thermostat, a smart garage door opener, a smart light device, a smart washing machine, a drone, a smart sound system, a smart television, a smart set-top box, an automobile, or smart clothing.

Example 13: the method of Examples 11 or 12, wherein the first communications network, the second communications network, and the third communications network are individually one of a local area network (LAN), a personal area network (PAN), a wireless local area network (WLAN), a wide area network (WAN), an enterprise private network (EPN), or a system-area network (SAN).

Example 14: the method of any of Examples 8-13, further comprising: responsive to receiving the transaction request, determining whether a change has occurred with respect to the first communications network from a previous transaction request by the user; responsive to determining that the change has not occurred with respect to the first communications network from a previous transaction request, requesting the authentication operation to be performed by the authentication device; and responsive to determining that the change has occurred with respect to the first communications network from the previous transaction request, initiating a strong consumer authentication of the user.

Example 15. A non-transitory computer-readable medium comprising instructions that, when executed by an electronic processor, cause the electronic processor to perform a set of operations comprising: receiving, with an electronic processor, a registration of an authentication device associated with a user, the authentication device connected to and operable to communicate over a first communications network; controlling, with the electronic processor, a memory to store the registration of the authentication device; receiving, with the electronic processor, a transaction request by the user; responsive to receiving the transaction request, requesting, with the electronic processor, an authentication operation to be performed by the authentication device; receiving, with the electronic processor, a result of the authentication operation performed by the authentication device; determining, with the electronic processor, whether the result validates the transaction request by the user; and permitting, with the electronic processor, the transaction request by the user in response to determining that the result validates the transaction request by the user.

Example 16: the non-transitory computer-readable medium of Example 15, wherein the authentication operation is an authentication challenge according to a 3DS 2.0 protocol.

Example 17: the non-transitory computer-readable medium of Examples 15 or 16, further comprising: receiving a registration of a second authentication device associated with the user, the second authentication device being separate and distinct from the authentication device, and the second authentication device being connected to and operable to communicate over a second communications network; controlling the memory to store the registration of the second authentication device; receiving a second transaction request by the user; responsive to receiving the second transaction request, requesting a second authentication operation to be performed by at least one of the authentication device or the second authentication device; receiving one or more results of the second authentication operation performed by the at least one of the authentication device or the second authentication device; determining whether the one or more results validate the second transaction request by the user; and permitting the second transaction request by the user in response to determining that the result validates the second transaction request by the user.

Example 18: the non-transitory computer-readable medium of Example 17, further comprising: receiving a registration of a third authentication device associated with the user, the third authentication device being separate and distinct from the authentication device and the second authentication device, and the second authentication device being connected to and operable to communicate over a third communications network; controlling the memory to store the registration of the third authentication device; receiving a third transaction request by the user;

responsive to receiving the third transaction request, requesting a third authentication operation to be performed by at least one of the authentication device, the second authentication device, or the third authentication device; receiving one or more results of the third authentication operation performed by the at least one of the authentication device, the second authentication device, or the third authentication device; determining whether the one or more results validate the third transaction request by the user; and permitting the third transaction request by the user in response to determining that the result validates the third transaction request by the user.

Example 19: the non-transitory computer-readable medium of Example 18, wherein the authentication device, the second authentication device, and the third authentication device are individually one of a smartphone, a tablet, laptop computer, a desktop computer, a smart watch, a smart refrigerator, a smart thermostat, a smart garage door opener, a smart light device, a smart washing machine, a drone, a smart sound system, a smart television, a smart set-top box, an automobile, or smart clothing.

Example 20: the non-transitory computer-readable medium of any of Examples 15-19, further comprising: responsive to receiving the transaction request, determining whether a change has occurred with respect to the first communications network from a previous transaction request by the user; responsive to determining that the change has not occurred with respect to the first communications network from a previous transaction request, requesting the authentication operation to be performed by the authentication device; and responsive to determining that the change has occurred with respect to the first communications network from the previous transaction request, initiating a strong consumer authentication of the user.

The above-described embodiments and enumerated examples of the present disclosure may be implemented in any of numerous ways. For example, the embodiments may be implemented using hardware, software, or a combination thereof. When implemented in software, the software code may be executed on any suitable processor or collection of processors, whether provided in a single computer or distributed among multiple computers.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the concepts disclosed herein may be embodied as a non-transitory computer-readable medium (or multiple computer-readable media) (e.g., a computer memory, one or more floppy discs, compact discs, optical discs, magnetic tapes, flash memories, circuit configurations in Field Programmable Gate Arrays or other semiconductor devices, or other non-transitory, tangible computer storage medium) encoded with one or more programs that, when executed on one or more computers or other processors, perform methods that implement the various embodiments of the present disclosure discussed above. The computer-readable medium or media may be transportable, such that the program or programs stored thereon may be loaded onto one or more different computers or other processors to implement various aspects of the present disclosure as discussed above.

The terms “program” or “software” are used herein to refer to any type of computer code or set of computer-executable instructions that may be employed to program a computer or other processor to implement various aspects of the present disclosure as discussed above. Additionally, it should be appreciated that according to one aspect of this embodiment, one or more computer programs that when executed perform methods of the present disclosure need not reside on a single computer or processor, but may be distributed amongst a number of different computers or processors to implement various aspects of the present disclosure.

Computer-executable instructions may be in many forms, such as program modules, executed by one or more computers or other devices. Program modules may include routines, programs, objects, components, data structures, etc. that perform particular tasks or implement particular abstract data types. The functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including the use of pointers, tags or other mechanisms that establish relationship between data elements.

Various features and aspects of the present disclosure may be used alone, in any combination of two or more, or in a variety of arrangements not specifically discussed in the embodiments described in the foregoing, and are therefore not limited to the details and arrangement of components set forth in the foregoing description or illustrated in the drawings. For example, aspects described in one embodiment may be combined in any suitable manner with aspects described in other embodiments.

Also, the concepts disclosed herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc. in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof, as well as additional items.

What is claimed is:

1. A computing device comprising:
an electronic processor; and
a memory,
wherein the electronic processor is configured to:
receive a registration of an authentication device associated with a user, the authentication device connected to and operable to communicate over a first communications network,
control the memory to store the registration of the authentication device,
receive a transaction request by the user,
responsive to receiving the transaction request, request an authentication operation to be performed by the authentication device,
receive a result of the authentication operation performed by the authentication device,
determine whether the result validates the transaction request by the user, and
permit the transaction request by the user in response to determining that the result validates the transaction request by the user.

2. The computing device of claim 1, wherein the authentication operation is an authentication challenge according to a 3DS 2.0 protocol.

3. The computing device of claim 1, wherein the electronic processor is further configured to:
receive a registration of a second authentication device associated with the user, the second authentication device being separate and distinct from the authentication device, and the second authentication device being connected to and operable to communicate over a second communications network,
control the memory to store the registration of the second authentication device,
receive a second transaction request by the user,
responsive to receiving the second transaction request, request a second authentication operation to be performed by at least one of the authentication device or the second authentication device,
receive one or more results of the second authentication operation performed by the at least one of the authentication device or the second authentication device,
determine whether the one or more results validate the second transaction request by the user, and
permit the second transaction request by the user in response to determining that the result validates the second transaction request by the user.

4. The computing device of claim 3, wherein the electronic processor is configured to:
receive a registration of a third authentication device associated with the user, the third authentication device being separate and distinct from the authentication device and the second authentication device, and the second authentication device being connected to and operable to communicate over a third communications network,
control the memory to store the registration of the third authentication device,
receive a third transaction request by the user,
responsive to receiving the third transaction request, request a third authentication operation to be performed by at least one of the authentication device, the second authentication device, or the third authentication device,
receive one or more results of the third authentication operation performed by the at least one of the authentication device, the second authentication device, or the third authentication device,
determine whether the one or more results validate the third transaction request by the user, and
permit the third transaction request by the user in response to determining that the result validates the third transaction request by the user.

5. The computing device of claim 4, wherein the authentication device, the second authentication device, and the third authentication device are individually one of a smartphone, a tablet, laptop computer, a desktop computer, a smart watch, a smart refrigerator, a smart thermostat, a smart garage door opener, a smart light device, a smart washing machine, a drone, a smart sound system, a smart television, a smart set-top box, an automobile, or smart clothing.

6. The computing device of claim 4, wherein the first communications network, the second communications network, and the third communications network are individually one of a local area network (LAN), a personal area network (PAN), a wireless local area network (WLAN), a wide area network (WAN), an enterprise private network (EPN), or a system-area network (SAN).

7. The computing device of claim 1, wherein the electronic processor is further configured to
responsive to receiving the transaction request, determine whether a change has occurred with respect to the first communications network from a previous transaction request by the user,
responsive to determining that the change has not occurred with respect to the first communications network from a previous transaction request, request the authentication operation to be performed by the authentication device,
responsive to determining that the change has occurred with respect to the first communications network from the previous transaction request, initiate a strong consumer authentication of the user.

8. A method comprising:
receiving, with an electronic processor, a registration of an authentication device associated with a user, the authentication device connected to and operable to communicate over a first communications network;
controlling, with the electronic processor, a memory to store the registration of the authentication device;
receiving, with the electronic processor, a transaction request by the user;
responsive to receiving the transaction request, requesting, with the electronic processor, an authentication operation to be performed by the authentication device;
receiving, with the electronic processor, a result of the authentication operation performed by the authentication device;
determining, with the electronic processor, whether the result validates the transaction request by the user; and
permitting, with the electronic processor, the transaction request by the user in response to determining that the result validates the transaction request by the user.

9. The method of claim 8, wherein the authentication operation is an authentication challenge according to a 3DS 2.0 protocol.

10. The method of claim 8, further comprising:
receiving a registration of a second authentication device associated with the user, the second authentication device being separate and distinct from the authentication device, and the second authentication device being connected to and operable to communicate over a second communications network;
controlling the memory to store the registration of the second authentication device;
receiving a second transaction request by the user;
responsive to receiving the second transaction request, requesting a second authentication operation to be performed by at least one of the authentication device or the second authentication device;
receiving one or more results of the second authentication operation performed by the at least one of the authentication device or the second authentication device;
determining whether the one or more results validate the second transaction request by the user; and
permitting the second transaction request by the user in response to determining that the result validates the second transaction request by the user.

11. The method of claim 10, further comprising:
receiving a registration of a third authentication device associated with the user, the third authentication device being separate and distinct from the authentication device and the second authentication device, and the second authentication device being connected to and operable to communicate over a third communications network;
controlling the memory to store the registration of the third authentication device;
receiving a third transaction request by the user;
responsive to receiving the third transaction request, requesting a third authentication operation to be performed by at least one of the authentication device, the second authentication device, or the third authentication device;
receiving one or more results of the third authentication operation performed by the at least one of the authentication device, the second authentication device, or the third authentication device;
determining whether the one or more results validate the third transaction request by the user; and
permitting the third transaction request by the user in response to determining that the result validates the third transaction request by the user.

12. The method of claim 11, wherein the authentication device, the second authentication device, and the third authentication device are individually one of a smartphone, a tablet, laptop computer, a desktop computer, a smart watch, a smart refrigerator, a smart thermostat, a smart garage door opener, a smart light device, a smart washing machine, a drone, a smart sound system, a smart television, a smart set-top box, an automobile, or smart clothing.

13. The method of claim 11, wherein the first communications network, the second communications network, and the third communications network are individually one of a local area network (LAN), a personal area network (PAN), a wireless local area network (WLAN), a wide area network (WAN), an enterprise private network (EPN), or a system-area network (SAN).

14. The method of claim 8, further comprising:
responsive to receiving the transaction request, determining whether a change has occurred with respect to the first communications network from a previous transaction request by the user;
responsive to determining that the change has not occurred with respect to the first communications network from a previous transaction request, requesting the authentication operation to be performed by the authentication device; and
responsive to determining that the change has occurred with respect to the first communications network from the previous transaction request, initiating a strong consumer authentication of the user.

15. A non-transitory computer-readable medium comprising instructions that, when executed by an electronic processor, cause the electronic processor to perform a set of operations comprising:
receiving, with an electronic processor, a registration of an authentication device associated with a user, the authentication device connected to and operable to communicate over a first communications network;
controlling, with the electronic processor, a memory to store the registration of the authentication device;
receiving, with the electronic processor, a transaction request by the user;
responsive to receiving the transaction request, requesting, with the electronic processor, an authentication operation to be performed by the authentication device;
receiving, with the electronic processor, a result of the authentication operation performed by the authentication device;
determining, with the electronic processor, whether the result validates the transaction request by the user; and
permitting, with the electronic processor, the transaction request by the user in response to determining that the result validates the transaction request by the user.

16. The non-transitory computer-readable medium of claim 15, wherein the authentication operation is an authentication challenge according to a 3DS 2.0 protocol.

17. The non-transitory computer-readable medium of claim 15, further comprising:
receiving a registration of a second authentication device associated with the user, the second authentication device being separate and distinct from the authentication device, and the second authentication device being connected to and operable to communicate over a second communications network;
controlling the memory to store the registration of the second authentication device;
receiving a second transaction request by the user;
responsive to receiving the second transaction request, requesting a second authentication operation to be performed by at least one of the authentication device or the second authentication device;
receiving one or more results of the second authentication operation performed by the at least one of the authentication device or the second authentication device;
determining whether the one or more results validate the second transaction request by the user; and
permitting the second transaction request by the user in response to determining that the result validates the second transaction request by the user.

18. The non-transitory computer-readable medium of claim 17, further comprising:
receiving a registration of a third authentication device associated with the user, the third authentication device being separate and distinct from the authentication device and the second authentication device, and the second authentication device being connected to and operable to communicate over a third communications network;
controlling the memory to store the registration of the third authentication device;
receiving a third transaction request by the user;
responsive to receiving the third transaction request, requesting a third authentication operation to be performed by at least one of the authentication device, the second authentication device, or the third authentication device;
receiving one or more results of the third authentication operation performed by the at least one of the authentication device, the second authentication device, or the third authentication device;
determining whether the one or more results validate the third transaction request by the user; and
permitting the third transaction request by the user in response to determining that the result validates the third transaction request by the user.

19. The non-transitory computer-readable medium of claim 18, wherein the authentication device, the second authentication device, and the third authentication device are individually one of a smartphone, a tablet, laptop computer, a desktop computer, a smart watch, a smart refrigerator, a smart thermostat, a smart garage door opener, a smart light device, a smart washing machine, a drone, a smart sound system, a smart television, a smart set-top box, an automobile, or smart clothing.

20. The non-transitory computer-readable medium of claim 15, further comprising:
responsive to receiving the transaction request, determining whether a change has occurred with respect to the first communications network from a previous transaction request by the user;
responsive to determining that the change has not occurred with respect to the first communications network from a previous transaction request, requesting the authentication operation to be performed by the authentication device; and
responsive to determining that the change has occurred with respect to the first communications network from the previous transaction request, initiating a strong consumer authentication of the user.
